(19) United States
(12) Patent Application Publication
(10) Pub. No.: US 2026/0302161 A1
(43) Pub. Date: Oct. 1, 2026

(54) ELECTRODE FORMING SYSTEM

(71) Applicant: SINTOKOGIO, LTD., Nagoya-shi, Aichi (JP)

(72) Inventors: Yuu ISHIDA, Shinshiro-shi, Aichi (JP); Harumitsu ASANO, Nagoya-shi, Aichi (JP); Yuichiro YOKOYAMA, Kyoto-shi, Kyoto (JP); Masaaki MORIZANE, Kyoto-shi, Kyoto (JP); Yusuke EMORI, Kyoto-shi, Kyoto (JP); Masanori SHIMADA, Kyoto-shi, Kyoto (JP); Hideaki HORIE, Echizen-shi, Fukui (JP)

(73) Assignee: SINTOKOGIO, LTD., Nagoya-shi, Aichi (JP)

(21) Appl. No.: 18/996,360

(22) PCT Filed: Sep. 6, 2023
(86) PCT No.: PCT/JP2023/032538

§ 371 Date: Jan. 17, 2025

(30) Foreign Application Priority Data
Sep. 8, 2022 (JP) 2022-143186

(51) Int. Cl. H01M 4/04

(52) U.S. Cl. CPC H01M 4/0435

(57) ABSTRACT

According to an aspect of the present disclosure, an electrode forming system for supplying powder to a substrate to form an electrode, the electrode forming system including: a transport device including a first electric actuator and a ball screw mechanism configured to continuously converting rotational motion generated by the first electric actuator into motion in a direction along a transport path and configured to transport the substrate along the transport path; a storage container configured to store the powder; and a roller configured to be operated by a second electric actuator and provided at a lower end of the storage container, the roller scraping the powder from within the storage container to a target region on the transport path along which the substrate can pass.

### CROSS-REFERENCE TO RELATED APPLICATIONS

This application is based on and claims the benefit of priority from Japanese Patent Application No. 2022-143186 filed on Sep. 8, 2022, and the entire contents of which are incorporated herein by reference.

### TECHNICAL FIELD The present disclosure relates to an electrode forming system.

### BACKGROUND

In Japanese Unexamined Patent Publication No. 2021-044154, a device for manufacturing an electrode for a lithium-ion battery that supplies an electrode composition onto a substrate is described. The device includes a belt conveyor on which the substrate is installed, a supply means for supplying a powder electrode composition onto the substrate, and a rack and pinion for moving a relative position between the supply means and the substrate.

### SUMMARY

In the manufacturing device for the lithium-ion battery electrode described in Japanese Unexamined Patent Publication No. 2021-044154, because a rigid rack and the pinion are repeatedly mated and separated, there is a risk that a gap between the tooth surfaces will change due to wear or the like, and periodic vibration may be transmitted to the pinion. For this reason, when powder is supplied to a substrate moved by a rack and pinion, a periodic difference in thickness and thinness (unevenness) may occur in the layer of powder supplied to the substrate.

The present disclosure provides an electrode forming system that suppresses the occurrence of periodic unevenness of powder supplied onto a substrate.

According to an embodiment of the present disclosure, an electrode forming system supplies powder to a substrate to form an electrode. The electrode forming system includes a transport device, a storage container, and a roller. The transport device includes a first electric actuator and a ball screw mechanism configured to continuously converting rotational motion generated by the first electric actuator into motion in a direction along a transport path and transports the substrate along the transport path. The storage container stores the powder. The roller is operated by a second electric actuator and provided at a lower end of the storage container. The roller scraps the powder from within the storage container to a target region on the transport path along which the substrate can pass.

In this electrode forming system, the substrate on which the electrode is formed is transported along the transport path by the transport device. The powder scraped from within the storage container by the roller operated by the second electric actuator is supplied to the substrate passing through the target region on the transport path. Here, the transport device includes the ball screw mechanism configured to continuously converting the rotational motion generated by the first electric actuator into the motion in the direction along the transport path. That is, the transport device can transport the substrate without using a rack and pinion that may cause a change in the gap between the tooth surfaces. For this reason, the occurrence of periodic vibrations by the transport device can be suppressed, and intermittent movement in the direction along the transport path can be suppressed. Therefore, this electrode forming system can suppress the occurrence of periodic unevenness of the powder supplied onto the substrate. Moreover, each of the transport device and the roller operates with an electric actuator, and therefore the operations of the transport device and the roller are precisely controlled compared with when each of the transport device and the roller is operated by a hydraulic or pneumatic actuator. Therefore, in this electrode forming system, the substrate is smoothly transported along the transport path by the transport device, and fluctuations in the amount of powder supplied to the substrate can be suppressed.

In the electrode forming system according to the embodiment, the transport device may include a mounting table on which the substrate is mounted and a guide mechanism configured to extend along the transport path and guide the mounting table along the transport path. In this case, because the movement of the mounting table in a direction other than a direction in which the guide mechanism is extended is suppressed, the substrate mounted on the mounting table is stably transported along the transport path. Therefore, this electrode forming system can suppress the occurrence of unevenness of the powder supplied onto the substrate.

According to the embodiment, the electrode forming system may include a distance sensor configured to measure a distance between the substrate and the roller and a support portion configured to support the storage container and configured to lift and lower the storage container directly above the target region, wherein the support portion may include a third electric actuator configured to lift and lower the storage container in accordance with the distance measured by the distance sensor. In this electrode forming system, because the distance between the substrate and the roller can be appropriately adjusted by the distance sensor and the third electric actuator, a thickness of a powder layer on the substrate can be uniform. Therefore, this electrode forming system can further suppress the occurrence of unevenness of the powder supplied onto the substrate. Moreover, the support portion is lifted and lowered by the third electric actuator, a process of lifting and lowering the support portion is precisely controlled compared with when the support portion is lifted and lowered by a hydraulic or pneumatic actuator. Therefore, in this electrode forming system, a process of positioning the storage container for the substrate can be performed with high accuracy, and fluctuations in the amount of powder supplied to the substrate can be suppressed.

According to the embodiment, the electrode forming system may further include a position measurement portion configured to measure a transport position of the substrate, wherein the transport device may control a transport speed of the substrate in accordance with the transport position of the substrate measured by the position measurement portion. In this electrode forming system, because the transport speed of the substrate is controlled, the amount of powder to be supplied can be adjusted in accordance with a location of the substrate. Thus, this electrode forming system can control a density of the powder on the substrate.

According to the embodiment, the electrode forming system may further include a position measurement portion configured to measure a transport position of the substrate, wherein the roller may control a rotational speed of the roller in accordance with the transport position of the substrate measured by the position measurement portion. It is possible to adjust an amount of powder to be supplied from the storage device to the substrate by controlling the rotational speed of the roller. In this electrode forming system, the amount of powder to be supplied from the storage container can be adjusted in accordance with the location of the substrate. Thus, this electrode forming system can control the density of the powder on the substrate.

In the electrode forming system according to the embodiment, the roller may control a rotational speed of the roller in accordance with a transport speed of the substrate in the transport device. The rotational speed of the roller is controlled, and therefore the amount of powder supplied from the storage device to the substrate can be adjusted. This electrode formation system can adjust the amount of powder in accordance with the transport speed, thereby controlling the density of the powder on the substrate.

According to another embodiment, an electrode forming system supplies powder to a substrate to form an electrode. The electrode forming system includes a transport device, a storage container, and a roller. The transport device includes a first electric actuator, a belt mechanism configured to continuously convert rotational motion generated by the first electric actuator into motion in a direction along a transport path, a mounting table on which the substrate is mounted, and a guide mechanism configured to extend along the transport path and guide the mounting table along the transport path, and transports the substrate along the transport path. The storage container stores the powder. The roller is operated by a second electric actuator and provided at a lower end of the storage container. The roller scraps the powder from within the storage container to a target region on the transport path along which the substrate can pass.

In this electrode forming system, the transport device includes the belt mechanism configured to continuously convert rotational motion generated by the first electric actuator into motion in the direction along the transport path, the mounting table, and the guide mechanism. This electrode forming system has an effect similar to that of the electrode forming system including the transport device having the ball screw mechanism described above.

The electrode forming system according to the present disclosure can suppress the occurrence of periodic unevenness of powder supplied onto a substrate.

### BRIEF DESCRIPTION OF THE DRAWINGS

FIG. 1 is a schematic side view showing an example of the electrode forming system according to an embodiment.

FIG. 2 is a schematic plan view showing the example of the electrode forming system according to the embodiment shown by line II-II of FIG. 1.

FIG. 3 is a flowchart showing an example of an electrode forming method for use in the electrode forming system according to the embodiment.

FIG. 4 is a graph showing an example of a rotational speed of a roller in the electrode forming system according to the embodiment.

### DETAILED DESCRIPTION

Hereinafter, embodiments of the present disclosure will be described with reference to the drawings. In the following description, the same or equivalent elements are denoted by the same reference numerals, and redundant description will be omitted. The dimensional proportions in the drawings do not always coincide with those in the description. The terms “above,” “below,” “before,” and “after” are based on the illustrated state and are provided for convenience.

### Overview of Electrode Formation System

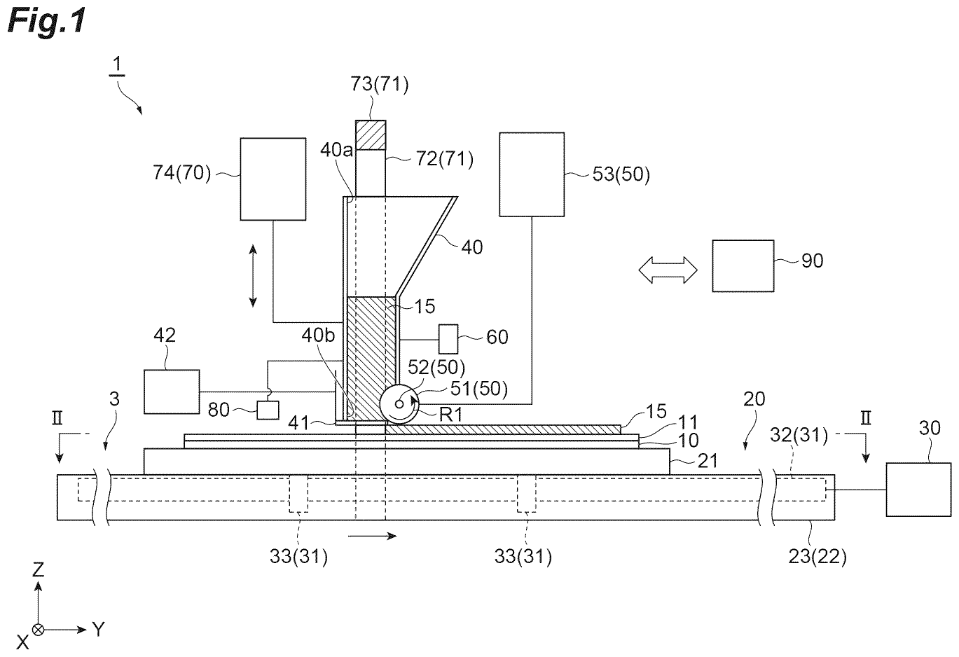

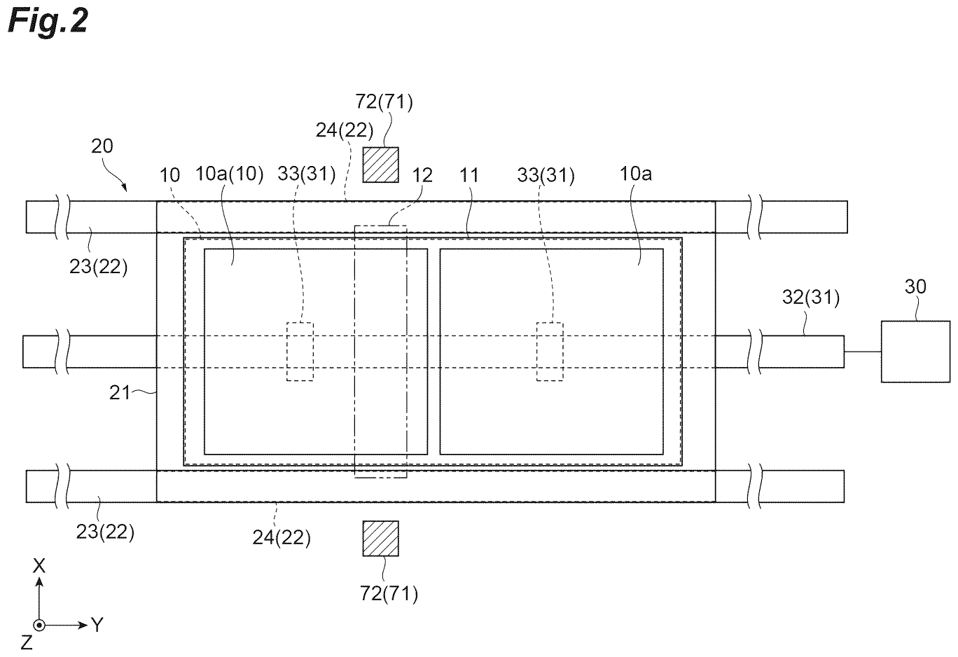

FIG. 1 is a schematic side view showing an example of the electrode forming system according to the embodiment. FIG. 2 is a schematic plan showing an example of an electrode forming system according to the embodiment shown by line II-II of FIG. 1. An X-axis and a Y-axis in FIG. 1 are coordinate axes in a horizontal direction and a Z-axis is a coordinate axis in a vertical direction. A direction along the X-axis, a direction along the Y-axis, and a direction along the Z-axis are orthogonal to each other in a Cartesian coordinate system of a three-dimensional space. Hereinafter, a direction along the Z-axis is also referred to as an upward/downward direction.

The electrode forming system 1 shown in FIG. 1 is a system in which powder 15 is supplied to the substrate 10 to form an electrode. The substrate 10 is a member constituting a battery, and is, for example, a current collector. As an example, the substrate 10 has a rectangular top surface extending in the direction along the X-axis and the direction along the Y-axis, the length of the substrate 10 in the direction along the X-axis is about 500 mm, and the length of the substrate 10 in the direction along the Y-axis is about 1200 mm. The powder 15 is an electrode material, for example, an electrode active material. The electrode active material is, as an example, a metal oxide containing lithium ions. The electrode forming system 1 forms an electrode by forming a coating film (layer) of the powder 15 on the substrate 10. The thickness of the coating film is, for example, 0.1 mm or more and 2.0 mm or less.

The electrode forming system 1 includes a transport device 20. The transport device 20 transports the substrate 10 along the transport path 3. The transport path 3 is a path along which the substrate 10 is transported. The transport path 3 shown in FIG. 1 extends along the Y-axis. The transport device 20 includes a mounting table 21 on which the substrate 10 is mounted, and a guide mechanism 22 that extends along the transport path 3 and can guide the mounting table 21 along the transport path 3.

The substrate 10 is mounted on the mounting table 21 and the mounting table 21 can be moved along the transport path 3. The mounting table 21 is a plate-shaped member extending along the X-axis and the Y-axis. For example, the substrate 10 and a mask member 11 covering the substrate 10 from above can be mounted on the upper surface of the mounting table 21. The substrate 10 may be mounted on a film (not shown) provided on the mounting table 21.

The mask member 11 is a plate-shaped member that covers a region where the powder 15 is not supplied to the substrate 10. As an example, the length of the outer edge of the mask member 11 in the direction along the X-axis is about 500 mm and the length of the outer edge in the direction along the Y-axis of the mask member 11 is about 1200 mm. The mask member 11 exhibits, for example, a frame that covers an outer edge portion of the substrate 10 and a central portion of the substrate 10 so that two supply regions 10a for supplying the powder 15 are arranged adjacent to each other in the direction along the Y-axis. Thereby, two electrodes are formed on one substrate 10 by the electrode forming system 1. The number of supply regions 10a provided in the substrate 10 is not limited to two. In the substrate 10, in a state in which the area of a supply region 10a is not changed, two supply regions 10a may be designated as one supply region 10a or three or more supply regions 10a. That is, the number of supply regions 10a is set arbitrarily. Furthermore, the number of electrodes formed on one substrate 10 by the electrode forming system 1 is not limited, and one or more electrodes are formed for one substrate 10 in accordance with the number of supply regions 10a. The sizes and shapes of the substrate 10, the mask member 11, and the mounting table 21 are appropriately adjusted in accordance with the number of the supply regions 10a, a size of the supply region 10a, and a shape of the supply region 10a provided for one substrate 10.

The two supply regions 10a are adjacent to each other to sandwich the central portion in the direction along the Y-axis. The length of each supply region 10a in the direction along the X-axis is about 400 mm and the length of each supply region 10a in the direction along the Y-axis is about 500 mm. The size of the supply region 10a is set in accordance with the size of the electrode formed on the substrate 10. As an example, the central portion of the substrate 10 is sandwiched between the two supply regions 10a and is a portion having an extension of 500 mm in the direction along the X-axis and having a width of about 50 mm in the direction along the Y-axis. As an example, the outer edge portion of the substrate 10 is a portion having a width of about 75 mm in the direction along the Y-axis on the basis of each end side (outer edge) having an extension of 500 mm in the direction along the X-axis in the substrate 10. As an example, the outer edge portion of the substrate 10 is a portion having a width of about 50 mm in the direction along the X-axis on the basis of each end side (outer edge) having an extension of 1200 mm in the direction along the Y-axis in the substrate 10. The mask member 11 is installed on the substrate 10 before the powder 15 is supplied to the substrate 10 by the electrode forming system 1. For example, in a plan view, the substrate 10 is installed to fit within the mounting table 21 and the mask member 11 is installed to fit within the mounting table 21.

The guide mechanism 22 guides the mounting table 21 along the Y-axis. The guide mechanism 22 is, for example, a linear guide. The guide mechanism 22 includes a pair of guide rails 23 and 23 and a pair of guide holding portions 24 and 24. The pair of guide rails 23 and 23 extend along the Y-axis. The pair of guide rails 23 and 23 are spaced apart by a predetermined width in the direction along the X-axis, for example, so that they are located directly below both end portions of the mounting table 21 in the direction along the X-axis. The pair of guide holding portions 24 and 24 are fixed to the mounting table 21. For example, the pair of guide holding portions 24 and 24 are fixed to the lower surface of both ends of the mounting table 21 in the direction along the X-axis.

The transport device 20 includes a drive mechanism 30 and a ball screw mechanism 31. The drive mechanism 30 drives the ball screw mechanism 31. The drive mechanism 30 is, for example, a first electric actuator. The electric actuator is an electric motor as an example.

The ball screw mechanism 31 can continuously convert rotational motion generated by the drive mechanism 30 into motion in the direction along the transport path 3. The ball screw mechanism 31 includes a moving shaft 32 and a moving member 33. The moving shaft 32 is, for example, a long screw shaft, which extends along the Y-axis. The moving shaft 32 is supported by a bearing (not shown) so that the moving shaft 32 can rotate around its central axis. A circumferential surface of the moving shaft 32 is continuously threaded. The moving shaft 32 is connected to the drive mechanism 30 and rotates under the drive of the drive mechanism 30.

The moving member 33 is fixed to the mounting table 21 and is provided so that the moving member 33 can rotate around the moving shaft 32. The moving member 33 is fixed, for example, to the lower surface of the mounting table 21. The moving member 33 moves along the Y-axis when the moving shaft 32 is rotated by motive power from the drive mechanism 30. The moving member 33 is, for example, a female screw or a nut bracket. Because the threading of the moving shaft 32 is formed continuously, the moving member 33 continuously spirals between a front end and a rear end of the moving shaft 32.

When the moving shaft 32 rotates forward (for example, rotates to the right), the moving member 33 moves in a positive Y-axis direction (a forward direction) with the mounting table 21 according to the rotation. When the moving shaft 32 is inverted (for example, rotated to the left), the moving member 33 moves in a negative Y-axis direction (a backward direction) with the mounting table 21 according to the rotation. The rotational motion generated by the drive mechanism 30 is continuously converted into the motion along the Y-axis of the moving member 33 according to the rotation of the moving shaft 32. When the moving member 33 moves along the Y-axis, the mounting table 21 fixed to the moving member 33 and the substrate 10 mounted on the mounting table 21 can move along the Y-axis. The mounting table 21 and the substrate 10 of the present embodiment are transported forward when the powder 15 is supplied.

The electrode forming system 1 includes a storage container 40 and a roller 50. The electrode forming system 1 scrapes the powder 15 from the storage container 40 with the roller 50 and supplies the powder 15 to the substrate 10 on the mounting table 21. The storage container 40 stores the powder 15. The storage container 40 is, for example, a hopper. The storage container 40 is provided above a predetermined position on the transport path 3. As a specific example, the storage container 40 is provided directly above the target region 12 on the transport path 3 along which the substrate 10 can pass.

The target region 12 is a part of the region on the transport path 3. The target region 12 can be arbitrarily set as a position for installation of a constituent element such as the storage container 40. The target region 12 is a region where the powder 15 is supplied by the storage container 40 and the roller 50. The target region 12 is, for example, a region through which the supply region 10a of the substrate 10 transported along the transport path 3 by the transport device 20 passes. The target region 12 is a region between the pair of guide rails 23 and 23 in the direction along the X-axis.

The storage container 40 is a cylindrical member penetrating in the vertical direction. In a top view, a front-end portion of the storage container 40 is inclined so that a space in the storage container 40 expands upward. An outer shape of the lower part of the storage container 40 exhibits a cuboid shape. The shape of the storage container 40 is not limited. An inlet 40a of an upper-end portion and an outlet 40b of a lower-end portion are formed in the storage container 40. The powder 15 passes through the inlet 40a and the outlet 40b. For example, the powder 15 is supplied into the storage container 40 from a supply source (not shown) via the inlet 40a. The powder 15 is supplied to the target region 12 in a downward direction via the outlet 40b of the storage container 40.

An opening/closing gate 41 is provided in the outlet 40b of the storage container 40. The opening/closing gate 41 controls an amount of powder 15 supplied from the storage container 40 to the substrate 10 by opening and closing the outlet 40b. The opening/closing gate 41 is, for example, a plate-shaped member extending in a direction along the X-axis and a direction along the Y-axis. The opening/closing gate 41, for example, is provided movable along the Y-axis. A position of the opening/closing gate 41 is controlled by the gate drive portion 42. The gate drive portion 42 is, for example, an electric actuator. According to the drive of the gate drive portion 42, the opening/closing gate 41 moves to a position of an open state or a position of a closed state.

The roller 50 is provided at a lower end of the storage container 40 and scrapes the powder 15 from within the storage container 40 with respect to the target region 12. The roller 50 includes a roller body portion 51, a rotating shaft 52, and a roller drive portion 53. The roller body portion 51 is provided, for example, at a lower end of a front side of the storage container 40 to scrape the powder 15 from within the storage container 40. The roller body portion 51 is a cylindrical member extending along the X-axis.

A rear side of the roller body portion 51 is located inside the storage container 40 and can be in contact with the powder 15. A front side of the roller body portion 51 is located outside the storage container 40. The rotating shaft 52 extends along the X-axis and is provided at the center of the roller body portion 51. The rotating shaft 52 is provided, for example, along the front surface of a lower portion of the storage container 40. The roller drive portion 53 controls the rotation of the roller body portion 51. The roller drive portion 53 is, for example, a second electric actuator. According to the drive of the roller drive portion 53, the roller body portion 51 rotates around the rotating shaft 52 in a direction of an arrow R1 in FIG. 1.

When the outlet 40b of the storage container 40 is closed, the opening/closing gate 41 is moved forward from the rear end of the storage container 40 by the gate drive portion 42 and comes into contact with the roller body portion 51. At this time, because the opening/closing gate 41 covers the outlet 40b of the storage container 40 from below, the powder 15 is not supplied from the outlet 40b of the storage container 40. When the outlet 40b of the storage container 40 is in the open state, the opening/closing gate 41 is separated from the roller body portion 51 by the gate drive portion 42 and moves toward the rear end of the storage container 40. When the outlet 40b is open, the roller body portion 51 rotates around the rotating shaft 52 and scrapes the powder 15 from within the storage container 40, and therefore the powder 15 can be smoothly supplied toward the target region 12.

A distance sensor 60 is provided in the storage container 40. The distance sensor 60 measures a distance between the substrate 10 and the roller 50. The distance sensor 60 is provided, for example, on a side surface of the storage container 40 and can be lifted and lowered together with the storage container 40. The distance sensor 60 measures a distance in the upward/downward direction between the substrate 10 mounted on the mounting table 21 and the roller body portion 51. The distance sensor 60 may measure, for example, a distance between the mask member 11 and the roller body portion 51, a distance between the mounting table 21 and the roller body portion 51, and the like. Hereinafter, the substrate 10, the mask member 11, and the mounting table 21 may be described as measurement targets.

The storage container 40 is supported by the support portion 70. The support portion 70 supports the storage container 40 so that the storage container 40 can be lifted and lowered directly above the target region 12. The support portion 70 includes a container support portion 71 and a lifting/lowering actuator 74. The container support portion 71 supports the storage container 40 so that the storage container 40 can be lifted and lowered directly above the target region 12. The container support portion 71 is, for example, a gate-shaped frame, and includes a pair of pillar members 72 located to face each other across the transport path 3 in the direction along the X-axis and extending in the upward/downward direction and a beam member 73 configured to connect upper portions of the pair of pillar members and extending in the direction along the X-axis. In FIG. 1, the pillar member 72 located in the negative X-axis direction is omitted. The pair of pillar members 72 is, for example, a pair of linear guides. The storage container 40 is lifted and lowered by the pair of pillar members 72. The container support portion 71 may support the gate drive portion 42, the roller drive portion 53, and the lifting/lowering actuator 74.

The lifting/lowering actuator 74 lifts and lowers the storage container 40. The lifting/lowering actuator 74 is, for example, a third electric actuator. By driving the lifting/lowering actuator 74, the storage container 40 moves in the upward/downward direction along the container support portion 71.

The transport position of the substrate 10 is measured by a position measurement portion 80. The position measurement portion 80, for example, measures the transport position of the measurement target including the substrate 10, the mask member 11, the mounting table 21, and the like. The transport position of the measurement target includes, for example, the relative position of each end portion of the measurement target from the target region 12 in the direction along the Y-axis. The position measurement portion 80 is provided above the transport path 3, for example, in the target region 12 or on an upstream side (a front side) of the transport path 3 from the target region 12. The position measurement portion 80 includes, for example, a light emitting portion and an image sensor. The position measurement portion 80 emits parallel laser light toward the transport path 3 with the light emitting portion and recognizes the reflection or shadow of parallel laser light with an image sensor. The position of the measurement target on the transport path 3 is measured according to an intensity of the reflected light recognized by the image sensor, an intensity of the shadow, and the like.

The control portion 90 controls the entire electrode forming system 1. The control portion 90 is configured as a programmable logic controller (PLC) as an example. The control portion 90 may be configured as a normal computer system including a central processing unit (CPU), main storage devices such as a random-access memory (RAM) and a read-only memory (ROM), an input device such as a touch panel or a keyboard, an output device such as a display, and an auxiliary storage device such as a hard disk.

The control portion 90 includes, for example, a manipulation panel that can be manipulated by a worker. The control portion 90 is communicatively connected to the transport device 20, the storage container 40, the roller 50, the distance sensor 60, the support portion 70, and the position measurement portion 80. The control portion 90 outputs control signals to the transport device 20, the roller 50, the distance sensor 60, the support portion 70, and the position measurement portion 80, and controls the operation of each configuration. The control portion 90 reads a pre-prepared program and causes the transport device 20, the roller 50, the distance sensor 60, the support portion 70, and the position measurement portion 80 to operate. The control portion 90 may operate the transport device 20, the roller 50, the distance sensor 60, the support portion 70, and the position measurement portion 80 in accordance with the worker's command manipulation received by the manipulation panel (not shown). The control portion 90 may be communicatively connected to the supply source of the powder 15 (not shown) and output a control signal to supply the powder 15 in accordance with the amount of powder 15 in the storage container 40.

The control portion 90 can operate the lifting/lowering actuator 74 in accordance with a distance measured by the distance sensor 60. The control portion 90 adjusts a position of the storage container 40 in the upward/downward direction so that there is a predetermined distance between the substrate 10 and the storage container 40, for example, on the basis of the shape of the mask member 11, the amount of powder 15 supplied from the storage container 40, and the like. The amount of powder 15 to be supplied from the storage container 40 is decided, for example, in accordance with a storage amount of the powder 15 in the storage container 40, a degree of opening of the opening/closing gate 41, a rotational speed of the roller 50, and the like. The control portion 90 drives the lifting/lowering actuator 74 to lift and lower the storage container 40, and the drive of the lifting/lowering actuator 74 is stopped when the distance measured by the distance sensor 60 becomes a predetermined distance. In this case, the storage container 40 is supported by the container support portion 71 with the predetermined distance from the substrate 10.

The control portion 90 can operate the transport device 20 and control the transport speed of the substrate 10 in accordance with the transport position of the substrate 10 measured by the position measurement portion 80. For example, the transport speed of the substrate 10 is reduced when the supply region 10a of the substrate 10 is located in the target region 12 compared with when the supply region 10a of the substrate 10 is located outside the target region 12. The control portion 90 may reduce the transport speed of the substrate 10 when it is difficult to supply the powder 15 to a boundary portion between the substrate 10 and the mask member 11.

The control portion 90 can operate the gate drive portion 42 and control the movement of the opening/closing gate 41 in accordance with the transport position of the substrate 10 measured by the position measurement portion 80. For example, the control portion 90 increases a degree of opening of the opening/closing gate 41 when the supply region 10a of the substrate 10 is located inside the target region 12, compared with when the supply region 10a of the substrate 10 is located outside the target region 12. The control portion 90 may control the movement of the opening/closing gate 41 so that the opening/closing gate 41 is in an open state immediately before the supply region 10a of the substrate 10 is located in the target region 12.

The control portion 90 can operate the roller drive portion 53 and control the rotational speed of the roller 50 in accordance with the transport position of the substrate 10 measured by the position measurement portion 80. For example, the control portion 90 drives the roller drive portion 53 so that the roller 50 (the roller body portion 51) has a predetermined rotational speed when the supply region 10a of the substrate 10 is located in the target region 12. The control portion 90 stops the drive of the roller drive portion 53 so that the rotational speed of the roller 50 becomes 0 when the supply region 10a of the substrate 10 is located outside the target region 12. When it is difficult to supply the powder 15 to a boundary portion between the substrate 10 and the mask member 11, the control portion 90 may control the roller drive portion 53, for example, so that the rotational speed of the roller 50 is increased. The control portion 90 may control the rotational speed of the roller 50 in accordance with the transport speed of the substrate 10. The control portion 90 may control the rotational speed of the roller 50 in accordance with the degree of opening of the opening/closing gate 41.

### Electrode Forming Method

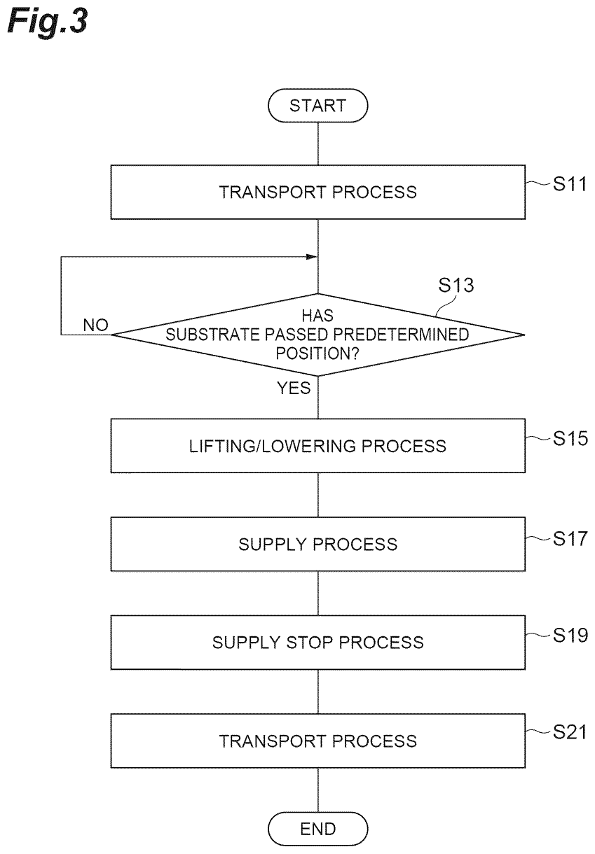

FIG. 3 is a flowchart showing an example of an electrode forming method for use in the electrode forming system according to the embodiment. The electrode forming method using the electrode forming system 1 of the present embodiment shown in FIG. 3 is started by the control portion 90 on the basis of the worker's instruction while the substrate 10 is mounted on the mounting table 21. First, as a transport process (S11), the transport device 20 transports the mounting table 21 on which the substrate 10 is mounted along the transport path 3. The drive mechanism 30 is driven and the moving shaft 32 of the ball screw mechanism 31 rotates in one direction, so that the moving member 33 moves forward (in the positive Y-axis direction). Because the moving member 33 is fixed to a lower surface of the mounting table 21, the mounting table 21 is transported forward. The mounting table 21 is guided forward by the guide mechanism 22. The drive mechanism 30, for example, makes an adjustment so that the transport speed until the substrate 10 enters the target region 12 is faster than the transport speed after the substrate 10 enters the target region 12.

Subsequently, the control portion 90 determines whether or not the substrate 10 has passed a predetermined position on the basis of the transport position of the measurement target acquired by the position measurement portion 80 as a position determination process (S13).

The predetermined position is a position in the vicinity of the target region 12 and is a position where the powder 15 will be supplied to the supply region 10a after a predetermined time. For example, when the position measurement portion 80 measures that the position of the rear end of the target region 12 coincides with the front end of the mounting table 21, the control portion 90 determines that the substrate 10 has passed the predetermined position. When the control portion 90 determines that the substrate 10 has passed the predetermined position (S13: YES), the transport device 20 reduces the transport speed of the substrate 10 and the control portion 90 moves to the next processing. When the control portion 90 determines that the substrate 10 has passed the predetermined position (S13: YES), for example, the control portion 90 moves the opening/closing gate 41 to the gate drive portion 42, and the outlet 40b of the storage container 40 is opened by a predetermined width. When the control portion 90 determines that the substrate 10 has not passed the predetermined position (S13: NO), the control portion 90 executes the position determination process (S13) again after a predetermined time.

Subsequently, the lifting/lowering actuator 74 lifts or lowers the storage container 40 so that the storage container 40 is located at a predetermined position as a lifting/lowering process (S15). For example, the control portion 90 causes the lifting/lowering actuator 74 to lift or lower the storage container 40 in accordance with a distance between the substrate 10 and the roller 50 measured by the distance sensor 60. The lifting/lowering actuator 74, for example, lifts or lowers the storage container 40 so that the storage container 40 is at a certain distance from the measurement target in the target region 12. For example, when the mask member 11 passes through the target region 12, the control portion 90 causes the lifting/lowering actuator 74 to lift and stop the storage container 40. For example, when the supply region 10a of the substrate 10 passes through the target region 12, the control portion 90 causes the lifting/lowering actuator 74 to lower and stop the storage container 40. This lifting/lowering process (S15) may be executed while the following other processes are being performed.

Subsequently, the storage container 40 and the roller 50 supply the powder 15 from the storage container 40 to the substrate 10 as a supply process (S17). The supply process (S17) is executed, for example, after a predetermined time from the position determination process (S13). The predetermined time is a value obtained by dividing a distance from the transport position of the substrate 10 measured in the position determination process (S13) to the target region 12 by the transport speed of the substrate 10 in the transport device 20. The supply process (S17) may be executed, for example, when the position measurement portion 80 determines that the supply region 10a of the substrate 10 has entered the target region 12. The control portion 90 controls the transport device 20, the gate drive portion 42, and the roller drive portion 53, for example, so that a predetermined amount of powder 15 is supplied in accordance with the location of the supply region 10a of the substrate 10 in the target region 12. A desired electrode is formed in the substrate 10 by supplying a predetermined amount of powder 15 in accordance with the location of the supply region 10a of the substrate 10 in the target region 12.

The drive mechanism 30 of the transport device 20 performs a drive process, for example, so that the transport speed of the substrate 10 becomes a predetermined speed in accordance with the location of the supply region 10a of the substrate 10 in the target region 12. The control portion 90 operates the gate drive portion 42 so that the opening/closing gate 41 is opened by a predetermined width in accordance with the location of the supply region 10a of the substrate 10 in the target region 12. The control portion 90 causes the roller drive portion 53 to rotate the roller 50 at a predetermined rotational speed in accordance with the location of the supply region 10a of the substrate 10 in the target region 12. At this time, the roller drive portion 53 controls the rotational speed of the roller 50 in accordance with the transport speed of the substrate 10 in the transport device 20. At least one of the degree of opening of the opening/closing gate 41, the transport speed of the substrate 10 in the transport device 20, and the rotational speed of the roller 50 is controlled in accordance with the transport position of the substrate 10 measured by the position measurement portion 80. Thereby, an electrode is formed in the substrate 10 to which the powder 15 is supplied. Moreover, while the supply process (S17) is being performed, the control portion 90 may control the transport speed of the substrate 10 in the transport device 20 and the rotational speed of the roller 50 in accordance with the transport position of the measurement target in the position measurement portion 80.

Subsequently, the storage container 40 and the roller 50 stop the supply of the powder 15 from the storage container 40 to the substrate 10 as a supply stop process (S19). The control portion 90 determines whether or not the supply region 10a of the substrate 10 has been transported outside the target region 12, for example, on the basis of the measurement result of the position measurement portion 80. Also, when it is determined that the supply region 10a of the substrate 10 has been transported outside the target region 12, the supply stop process (S19) is executed. The gate drive portion 42 moves the opening/closing gate 41 to a position of a closed state, for example, so that the powder 15 is not supplied from the storage container 40. The roller drive portion 53 stops the rotation of the roller 50, for example, so that the powder 15 is not supplied from the storage container 40.

Subsequently, the transport device 20 transports the mounting table 21 outside the target region 12 as a transport process (S21). When the transport process (S21) is completed, the electrode forming method using the electrode forming system 1 is completed.

### Example in Which Rotational Speed of Roller is Controlled

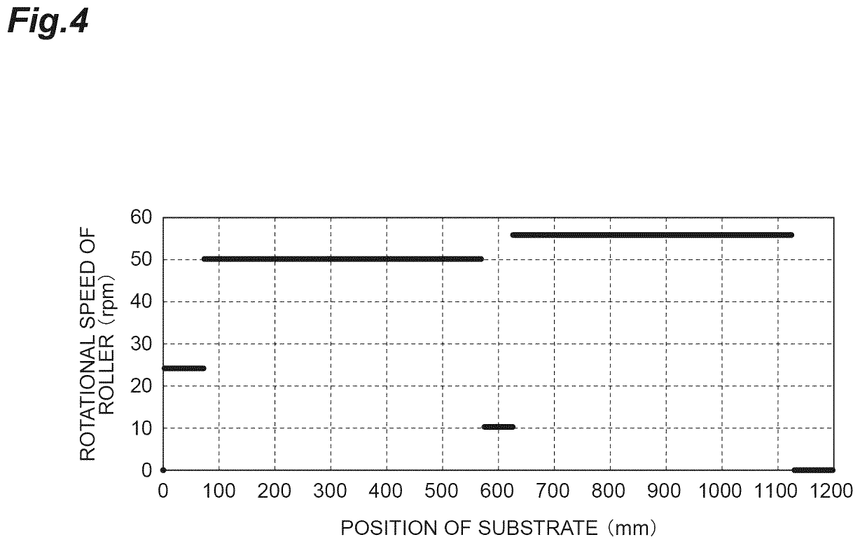

Here, a specific example of control of the rotational speed of the roller 50 in the above-described electrode forming method will be described. The dimensions, speeds, control timings, and the like of the following constituent elements are examples. FIG. 4 is a graph showing an example of the rotational speed of the roller 50 in the electrode forming system according to the embodiment. The graph shown in FIG. 4 shows a relationship between the positions of the substrate 10 before and after the supplying process (S17) and the rotational speed of the roller 50. The horizontal axis represents a position (mm) of the substrate 10 and the vertical axis represents a rotational speed (rpm) of the roller body portion 51 in the roller 50. The position of the substrate 10 is a position in a direction along the Y-axis of the substrate 10 mounted on the mounting table 21 passing through the target region 12 directly below the storage container 40. A length of the substrate 10 in the direction along the Y-axis is 1200 mm and the mask member 11 is installed on the substrate 10. The mask member 11 covers a region of 75 mm from a front end in the direction along the Y-axis of the substrate 10 (a region of 0 mm or more and less than 75 mm from the front end), a region of a central portion in the direction along the Y-axis of the substrate 10 (a region of 575 mm or more and less than 625 mm from the front end) and a region of 75 mm from the rear end in the direction along the Y-axis of the substrate 10 (a region of 1125 mm or more and 1200 mm or less from the front end). That is, the substrate 10 has a first supply region of 75 mm or more and less than 575 mm from the front end of the substrate and a second supply region of 625 mm or more and less than 1125 mm from the front end of the substrate as the supply region 10a. In this example, it is assumed that the position of the front end of the mounting table 21 coincides with the position of the front end of the substrate 10 (the mask member 11). Moreover, in this example, there is no supply of powder from the source to the storage container 40. The control portion 90 acquires information in advance about the above-described substrate 10, the mask member 11, the powder 15, the mounting table 21, the electrode to be formed, and the like.

The substrate 10 is transported by the transport device 20 in the transport process (S11). When it is determined that the substrate 10 has passed the predetermined position in the position determination process (S13), the position of the rear end of the target region 12 (an end portion in the negative Y-axis direction) coincides with the position of the front end of the mask member 11 (an end portion in the positive Y-axis direction). After the determination, the lifting/lowering process (S15) is executed and the supply process (S17) is executed. The roller 50 rotates at a low speed while the mask member 11 passes through the target region 12. Although it is not necessary to supply the powder 15 to the mask member 11, the control portion 90 rotates the roller 50 in advance so that a predetermined amount of powder 15 is supplied when the first supply region of the substrate 10 enters the rear end of the target region 12. For example, when a region of 0 mm or more and less than 70 mm from the front end of the substrate 10 passes through the target region, the control portion 90 rotates the roller 50 at 24 rpm.

Because it is necessary to supply a predetermined amount of powder 15 to the substrate 10 in the first supply region of 75 mm or more and less than 575 mm from the front end of the substrate 10, a state in which the predetermined amount of powder 15 can be supplied is required to be set before the position of 75 mm from the front end of the substrate 10 passes through the rear end of the target region 12. For this reason, the control portion 90 changes the rotational speed of the roller 50 to a high speed. The control portion 90, for example, changes the rotational speed of the roller 50 from 24 rpm to 50 rpm when a position of 70 mm from the front end of the substrate 10 passes through the rear end of the target region 12.

Although a region of 575 mm or more and less than 625 mm from the front end of the substrate 10 is a region where the mask member 11 covers the substrate 10, it is necessary to suppress a process in which a predetermined amount of powder 15 is not supplied in the rear-end portion of the first supply region (a region around 575 mm from the front end of the substrate). Moreover, because the rear-end portion of the first supply region is close to a boundary with the mask member 11, it is necessary to prevent the rise of the powder 15 from forming at a boundary portion. For this reason, the control portion 90, for example, maintains the rotational speed of the roller 50 at 50 rpm until a region up to 575 mm from the front end of the substrate 10 passes through the front end of the target region 12. Also, while a region of 575 mm or more and less than 620 mm from the front end of the substrate 10 passes through the target region 12, the control portion 90 rotates the roller 50 at a low speed to supply a predetermined amount of powder 15 toward the mask member 11. Although it is not necessary to supply the powder 15 to the mask member 11, the control portion 90 continuously rotates the roller 50 so that a predetermined amount of powder 15 is supplied when the second supply region of the substrate 10 has entered the rear end of the target region 12. For example, when a region of 575 mm or more and less than 620 mm from the front end of the substrate 10 passes through the target region, the control portion 90 changes the rotational speed of the roller 50 to 10 rpm.

Because a predetermined amount of powder 15 needs to be supplied to the substrate 10 in the second supply region of 625 mm or more and less than 1125 mm from the front end of the substrate 10, a state in which the predetermined amount of powder 15 can be supplied is required to be set before a position of 625 mm from the front end of the substrate 10 passes through the rear end of the target region 12. For this reason, the control portion 90 changes the rotational speed of the roller 50 to a high speed. Moreover, compared with when the powder 15 is supplied to the first supply region, when the powder 15 is supplied to the second supply region, because the amount of powder stored in the storage container 40 is small, it is necessary for the roller 50 to properly scrape the powder 15 so that an appropriate amount of powder 15 is supplied from the storage container 40. For example, the control portion 90 increases the rotational speed of the roller 50 when the second supply region passes through the target region 12 compared with when the first supply region passes through the target region 12. The control portion 90 changes the rotational speed of the roller 50 from 10 rpm to 56 rpm, for example, when a position of 620 mm from the front end of the substrate passes through the rear end of the target region 12.

Although a region of 1125 mm or more and 1200 mm or less from the front end of the substrate 10 is a region where the mask member 11 covers the substrate 10, it is necessary to suppress a process in which a predetermined amount of powder 15 is not supplied in the rear-end portion of the second supply region (a region around 1125 mm from the front end of the substrate). For this reason, even if the rear end of the second supply region passes through the target region 12, the control portion 90, for example, maintains a rotational speed of the roller 50 at a high speed of 56 rpm until a region up to 1130 mm from the front end of the substrate 10 passes through the front end of the target region 12. Although it is necessary to prevent the rise of the powder from being formed at the boundary between the second supply region and the mask member 11, because the amount of powder 15 in the storage container 40 is reduced, the rise of the powder 15 is not formed even if the high speed is maintained. While a region of 1130 mm or more and 1200 mm or less from the front end of the substrate 10 passes through the target region 12, the control portion 90 determines that the supply region 10a of the substrate 10 has been transported outside the target region 12 and stops the rotation of the roller 50 as a supply stop process (S19). Thus, the control portion 90 can supply an appropriate amount of powder 15 to each position of the substrate 10 by controlling the rotational speed of the roller 50 on the basis of the transport position of the substrate 10.

### SUMMARY OF EMBODIMENTS

The electrode forming system 1 of the present embodiment supplies powder 15 to the substrate 10 to form an electrode. The electrode forming system 1 includes the transport device 20, the storage container 40, and the roller 50. The transport device 20 includes the drive mechanism 30 (an example of a first electric actuator) and the ball screw mechanism 31 configured to continuously convert (capable of continuously converting) rotational motion generated by the drive mechanism into motion in the direction along the transport path and transports the substrate 10 along the transport path 3. The storage container 40 stores the powder 15. The roller 50 is operated by the roller drive portion 53 (an example of a second electric actuator), provided at a lower end of the storage container 40, and scraps the powder from within the storage container 40 to the target region 12 on the transport path 3 along which the substrate 10 can pass.

In the electrode forming system 1, the substrate 10 on which the electrode is formed is transported along the transport path 3 by the transport device 20. The powder 15 scraped from within the storage container 40 by the roller 50 is supplied to the substrate 10 passing through the target region 12 on the transport path 3. Here, the transport device 20 has the ball screw mechanism 31 configured to continuously convert (capable of continuously converting) rotational motion generated by the drive mechanism 30 into motion in the direction along the transport path 3. That is, the transport device 20 can transport the substrate 10 without using a rack and pinion that may cause a change in a gap between tooth surfaces. For this reason, the occurrence of periodic vibration by the transport device 20 is suppressed and it is possible to suppress intermittent movement in the direction along the transport path 3. Therefore, the electrode forming system 1 can suppress the periodic unevenness of the powder 15 supplied onto the substrate 10. Moreover, the occurrence of periodic unevenness is suppressed, and therefore it is avoided that the desired amount of powder is not supplied in accordance with the location of the substrate and the occurrence of electrode molding defects is suppressed. Furthermore, when only a belt conveyor is used as the transport device of the substrate 10, an amount of flexing of the belt varies with a distance between rotating bodies supporting the belt and a weight and position of the substrate mounted on the belt. The transport device 20 of the present embodiment can transport the substrate 10 without using the belt conveyor in which the distance or inclination between the storage container 40 and the roller 50 and the substrate 10 is likely to fluctuate.

Moreover the transport device 20 is operated by the drive mechanism 30 that is an electric actuator and the roller 50 is operated by the roller drive portion 53 that is an electric actuator. In this case, the operations of the transport device 20 and the roller 50 are precisely controlled compared with a case where each of the transport device 20 and the roller 50 is operated by a hydraulic or pneumatic actuator. Also, in this case, a thickness of a layer of the powder 15 supplied to the substrate 10 can be made uniform. Uniformity here indicates a state in which a difference between a maximum height of the layer and a minimum height of the layer is 50 μm or less or 30 μm or less when the thickness of the layer is 0.1 mm or more and 2.0 mm or less. Therefore, in the electrode forming system 1, the substrate 10 is smoothly transported along the transport path 3 by the transport device 20 and fluctuations in the amount of powder 15 supplied to the substrate 10 can be suppressed. Moreover, the gate drive portion 42 is an electric actuator. The electrode forming system 1 can appropriately perform an intermittent operation such as starting and stopping the supply of the powder 15 from the storage container 40 according to the operation of the opening/closing gate 41, the gate drive portion 42, and the roller 50 and can adjust a fine supply amount of powder 15.

Moreover, the transport device 20 includes the mounting table 21 on which the substrate 10 is mounted, and the guide mechanism 22 that extends along the transport path 3 and can guide the mounting table 21 along the transport path 3. In this case, because the movement of the mounting table 21 in a direction other than the direction (the direction along the Y-axis) in which the guide mechanism 22 extends (for example, the direction along the X-axis and the direction along the Z-axis) is suppressed, the substrate 10 mounted on the mounting table 21 is stably transported along the transport path 3. Therefore, the electrode forming system 1 can suppress the occurrence of unevenness in the powder 15 supplied onto the substrate 10.

Moreover, the electrode forming system 1 includes the distance sensor 60 configured to measure a distance between the substrate 10 and the roller 50 and the support portion 70 configured to support the storage container 40 and configured to (so that the support portion 70 is able to) lift and lower the storage container 40 directly above the target region 12, wherein the support portion 70 includes the lifting/lowering actuator 74 (an example of a third electric actuator) configured to lift and lower the storage container 40 in accordance with the distance measured by the distance sensor 60. Because the distance between the substrate 10 and the roller 50 can be appropriately adjusted by the distance sensor 60 and the lifting/lowering actuator 74, the electrode forming system 1 can uniformly reduce the thickness of the layer of the powder 15 on the substrate 10. For example, because a length between an upper end of the substrate 10 and a lower end of the roller body portion 51 is a thickness of a layer of the powder 15, the roller body portion 51 maintains a certain distance from the substrate 10, such that the thickness of the layer of the powder 15 can be made uniform. Therefore, the electrode forming system 1 can further suppress the occurrence of unevenness in the powder 15 supplied onto the substrate 10.

Moreover, the lifting/lowering actuator 74 is an electric actuator. In this case, the operation of the lifting/lowering actuator 74 is precisely controlled compared to a case where the lifting/lowering actuator 74 is a hydraulic or pneumatic actuator. Therefore, in the electrode forming system 1, the positioning of the storage container 40 for the substrate 10 can be performed with high accuracy, and fluctuations in the amount of powder 15 supplied to the substrate 10 can be suppressed.

Moreover, the electrode forming system 1 further includes the position measurement portion 80 configured to measure the transport position of the substrate 10, wherein the transport device 20 controls the transport speed of the substrate 10 in accordance with the transport position of the substrate 10 measured by the position measurement portion 80. In the electrode forming system 1, because the transport speed of the substrate 10 is controlled, the amount of powder 15 to be supplied can be adjusted in accordance with the location of the substrate 10. For example, when the transport speed of the substrate 10 increases, the amount of powder 15 per unit area decreases, so that the layer of the powder 15 formed on the substrate 10 becomes sparse. On the other hand, for example, when the transport speed of the substrate 10 slows down, because the amount of powder 15 per unit area increases, the layer of powder 15 formed on the substrate 10 becomes dense. Therefore, the electrode forming system 1 can control the density of the powder 15 on the substrate 10.

Moreover, the roller 50 may control the rotational speed in accordance with the transport position of the substrate 10 measured by the position measurement portion 80. By controlling the rotational speed of the roller body portion 51 of the roller 50, an amount of powder 15 to be supplied from the storage container 40 to the substrate 10 can be adjusted. In the electrode forming system 1, the amount of powder 15 to be supplied from the storage container 40 can be adjusted in accordance with the position of the substrate 10. For example, when the rotational speed of the roller 50 slows down, because the amount of powder 15 to be supplied from the storage container 40 decreases, the layer of powder 15 formed on the substrate 10 becomes sparse. On the other hand, for example, when the rotational speed of the roller 50 increases, because the amount of powder 15 from the storage container 40 increases, the layer of the powder 15 formed on the substrate 10 becomes dense. Therefore, the electrode forming system 1 can control the density of the powder 15 on the substrate 10.

Moreover, the roller 50 controls the rotational speed in accordance with the transport speed of the substrate 10 in the transport device 20. By controlling the rotational speed of the roller 50, the amount of powder 15 to be supplied from the storage container 40 to the substrate 10 can be adjusted. The electrode forming system 1 can more precisely control the density of the powder 15 on the substrate 10 by adjusting the amount of powder 15 that is supplied in accordance with the transport speed.

### Modified Example

The above-described embodiment shows an example of the electrode forming system according to the present disclosure. The electrode forming system according to the present disclosure is not limited to the electrode forming system 1 according to the embodiment, and the electrode forming system 1 according to the embodiment may be modified or applied to other systems without changing the subject matter described in the accompanying claims.

For example, at least one of the transport device 20 and the roller 50 may not be operated by an electric actuator. In this example, at least one of the transport device 20 and the roller 50 may be operated by a hydraulic or pneumatic actuator. For example, the transport device 20 may not have at least one of the mounting table 21 and the guide mechanism 22. In this example, the transport device 20 may transport the substrate 10 with the drive mechanism 30 and the ball screw mechanism 31.

For example, the electrode forming system 1 may not include at least one of the distance sensor 60 and the support portion 70. In this example, the electrode forming system 1 may be provided by fixing the storage container 40 at a height where the powder 15 is supplied to the substrate 10 so that the storage container 40 cannot be lifted or lowered. The lifting/lowering actuator 74 does not have to be an electric actuator. In this example, the lifting/lowering actuator 74 may be a hydraulic or pneumatic actuator.

For example, the position measurement portion 80 may not have a light emitting portion and an image sensor. In this example, the drive mechanism 30 may include a servo motor. In the drive mechanism 30, an encoder of a servo motor may be the position measurement portion 80 and the position of the measurement target may be controlled by an output of the encoder. For example, the electrode forming system 1 may not include the position measurement portion 80. In this example, the electrode forming system 1 may operate the constituent elements such as the transport device 20, the gate drive portion 42, and the roller 50 in accordance with a predetermined program with respect to the substrate 10 transported at predetermined intervals. For example, the roller 50 may not control the rotational speed in accordance with the transport speed of the substrate 10 in the transport device 20. In this example, the roller 50 may control the rotational speed independently of the transport speed of the substrate 10 in the transport device 20.

For example, the transport device 20 may have a belt mechanism configured to continuously convert (capable of continuously converting) rotational motion generated by the drive mechanism 30 into motion in the direction along the transport path 3. The transport device 20 of the electrode forming system 1 includes at least one of the ball screw mechanism 31 and the belt mechanism described above. That is, the transport device 20 may have the belt mechanism instead of the ball screw mechanism 31. When the transport device 20 has the belt mechanism, the transport device 20 further includes the mounting table 21 on which the substrate 10 is mounted, and a guide mechanism that extends along the transport path 3 and can guide the mounting table 21 along the transport path 3. The transport device 20 may not have the mounting table 21. The transport device 20 includes, for example, a first rotor rotatably fixed to the drive mechanism 30, a belt member configured to rotate in continuous contact with the rotor, and a second rotor provided at a predetermined position in the transport path 3 separated from the first rotor and configured to rotatably support the belt member. The first rotor exhibits, for example, a cylindrical shape, and rotates according to the drive of the drive mechanism 30. The second rotor exhibits, for example, a cylindrical shape, and is rotatable. The belt member is, for example, an annular band and an elastic body. An inner circumferential surface of the belt member comes into contact with a circumferential surface of the first rotor and a circumferential surface of the second rotor and extends along the transport path 3 between the first rotor and the second rotor. The belt member is sent out, for example, by the force of rotation of the first rotor by friction. As the belt member moves due to the friction, the second rotor also rotates. The mounting table 21 is fixed, for example, to a belt member. In accordance with the drive of the drive mechanism 30, the belt member moves and therefore the mounting table 21 moves in the direction along the Y-axis. The first rotor may be, for example, a gear. In this example, the belt member may have an unevenness that meshes with the first rotor.

In an electrode forming system in which the transport device 20 has the belt mechanism, the substrate 10 on which the electrode is formed is transported along the transport path 3 by the transport device 20. The powder 15 scraped from within the storage container 40 by the roller 50 is supplied to the substrate 10 passing through the target region 12 on the transport path 3. The transport device 20 can transport the substrate 10 by the belt mechanism without using a rack and pinion that may cause a change in a gap between the tooth surfaces. For this reason, the occurrence of periodic vibrations in the direction along the Y-axis by the transport device 20 is suppressed and a state in which movement in the direction along the transport path 3 becomes intermittent movement can be suppressed. Therefore, the electrode forming system 1 can suppress the occurrence of periodic unevenness in the direction along the Y-axis of the powder 15 to be supplied onto the substrate 10. Moreover, the occurrence of periodic unevenness is suppressed, and therefore it is avoided that the desired amount of powder is not supplied according to the location of the substrate and the occurrence of electrode molding defects is suppressed. Moreover, because the transport device 20 has the guide mechanism 22, the movement of the mounting table 21 in a direction other than the direction (the direction along the Y-axis) in which the guide mechanism 22 extends (for example, the direction along the X-axis and the direction along the Z-axis) is suppressed, the substrate 10 mounted on the mounting table 21 is stably transported along the transport path 3. Therefore, this electrode forming system can suppress the occurrence of unevenness in the powder 15 to be supplied onto the substrate 10. Unlike the above-described case where only a belt conveyor is used as the transport device of the substrate 10, a deviation of the direction along the X-axis and the direction along the Z-axis due to an amount of deflection of the belt is suppressed by the guide mechanism 22. The transport device 20 having the belt mechanism and the guide mechanism can transport the substrate 10 by suppressing fluctuations in a distance or inclination between the storage container 40 and the roller 50 and the substrate 10.

For example, some of the steps of the electrode forming method in the above-described embodiment may be order-independent. That is, the steps can be executed in an order different from the described order or at the same time. For example, the constituent elements may operate in advance before the supply process (S17) (before the supply region 10a of the substrate 10 enters the target region 12) so that an appropriate amount of powder 15 is supplied to the supply region 10a when the position measurement portion 80 determines that the supply region 10a of the substrate 10 has entered the target region 12 before the supply process (S17). For example, the transport device 20 may adjust the transport speed of the substrate 10, the gate drive portion 42 may open the opening/closing gate 41 in advance, and the roller drive portion 53 may rotate the roller body portion 51. Even if the powder 15 is supplied before the supply region 10a of the substrate 10 enters the target region 12, because the powder 15 is supplied to the mask member 11, a coating film is not formed in the region of the substrate 10 other than the supply region 10a.

Here, various exemplary embodiments included in the present disclosure are described in the following articles 1 to 7.

### Article 1

An electrode forming system for supplying powder to a substrate to form an electrode, the electrode forming system including:
a transport device including a first electric actuator and a ball screw mechanism configured to continuously convert rotational motion generated by the first electric actuator into motion in a direction along a transport path and configured to transport the substrate along the transport path;
a storage container configured to store the powder; and
a roller configured to be operated by a second electric actuator and provided at a lower end of the storage container, the roller scraping the powder from within the storage container to a target region on the transport path along which the substrate can pass.

### Article 2

The electrode forming system according to article 1, wherein the transport device includes a mounting table on which the substrate is mounted and a guide mechanism configured to extend along the transport path and guide the mounting table along the transport path.

### Article 3

An electrode forming system for supplying powder to a substrate to form an electrode, the electrode forming system including:
a transport device including a first electric actuator, a belt mechanism configured to continuously convert rotational motion generated by the first electric actuator into motion in a direction along a transport path, a mounting table on which the substrate is mounted, and a guide mechanism configured to extend along the transport path and guide the mounting table along the transport path, and configured to transport the substrate along the transport path;
a storage container configured to store the powder; and
a roller configured to be operated by a second electric actuator and provided at a lower end of the storage container, the roller scraping the powder from within the storage container to a target region on the transport path along which the substrate can pass.

### Article 4

The electrode forming system according to any one of articles 1 to 3, including:
a distance sensor configured to measure a distance between the substrate and the roller; and
a support portion configured to support the storage container and configured to lift and lower the storage container directly above the target region,
wherein the support portion includes a third electric actuator configured to lift and lower the storage container in accordance with the distance measured by the distance sensor.

### Article 5

The electrode forming system according to any one of articles 1 to 4, further including a position measurement portion configured to measure a transport position of the substrate, wherein the transport device controls a transport speed of the substrate in accordance with the transport position of the substrate measured by the position measurement portion.

### Article 6

The electrode forming system according to any one of articles 1 to 5, further including a position measurement portion configured to measure a transport position of the substrate, wherein the roller controls a rotational speed of the roller in accordance with the transport position of the substrate measured by the position measurement portion.

### Article 7

The electrode forming system according to any one of articles 1 to 6, wherein the roller controls a rotational speed of the roller in accordance with a transport speed of the substrate in the transport device.

### REFERENCE SIGNS LIST

1 Electrode forming system, 3 Transport path, 10 Substrate, 12 Target region, 15 Powder, 20 Transport device, 21 Mounting table, 22 Guide mechanism, 30 Drive mechanism, 31 Ball screw mechanism, 40 Storage container, 41 Opening/closing gate, 42 Gate drive portion, 50 Roller, 60 Distance sensor, 70 Support portion, 74 Lifting/lowering actuator, 80 Position measurement portion, 90 Control portion

1-7: (canceled)

8: An electrode forming system for supplying powder to a substrate to form an electrode, the electrode forming system comprising:
a transport device including a first electric actuator and a ball screw mechanism configured to continuously convert rotational motion generated by the first electric actuator into motion in a direction along a transport path and configured to transport the substrate along the transport path;
a storage container configured to store the powder; and
a roller configured to be operated by a second electric actuator and provided at a lower end of the storage container, the roller scraping the powder from within the storage container to a target region on the transport path along which the substrate can pass.

9: The electrode forming system according to claim 8, wherein the transport device includes a mounting table on which the substrate is mounted and a guide mechanism configured to extend along the transport path and guide the mounting table along the transport path.

10: An electrode forming system for supplying powder to a substrate to form an electrode, the electrode forming system comprising:
a transport device including a first electric actuator, a belt mechanism configured to continuously convert rotational motion generated by the first electric actuator into motion in a direction along a transport path, a mounting table on which the substrate is mounted, and a guide mechanism configured to extend along the transport path and guide the mounting table along the transport path, and configured to transport the substrate along the transport path;
a storage container configured to store the powder; and
a roller configured to be operated by a second electric actuator and provided at a lower end of the storage container, the roller scraping the powder from within the storage container to a target region on the transport path along which the substrate can pass.

11. : The electrode forming system according to claim 8, comprising:
a distance sensor configured to measure a distance between the substrate and the roller; and
a support portion configured to support the storage container and configured to lift and lower the storage container directly above the target region,
wherein the support portion includes a third electric actuator configured to lift and lower the storage container in accordance with the distance measured by the distance sensor.

12: The electrode forming system according to claim 9, comprising:
a distance sensor configured to measure a distance between the substrate and the roller; and
a support portion configured to support the storage container and configured to lift and lower the storage container directly above the target region,
wherein the support portion includes a third electric actuator configured to lift and lower the storage container in accordance with the distance measured by the distance sensor.

13: The electrode forming system according to claim 10, comprising:
a distance sensor configured to measure a distance between the substrate and the roller; and
a support portion configured to support the storage container and configured to lift and lower the storage container directly above the target region,
wherein the support portion includes a third electric actuator configured to lift and lower the storage container in accordance with the distance measured by the distance sensor.

14: The electrode forming system according to claim 8, further comprising a position measurement portion configured to measure a transport position of the substrate,
wherein the transport device controls a transport speed of the substrate in accordance with the transport position of the substrate measured by the position measurement portion.

15: The electrode forming system according to claim 9, further comprising a position measurement portion configured to measure a transport position of the substrate,
wherein the transport device controls a transport speed of the substrate in accordance with the transport position of the substrate measured by the position measurement portion.

16: The electrode forming system according to claim 10, further comprising a position measurement portion configured to measure a transport position of the substrate,
wherein the transport device controls a transport speed of the substrate in accordance with the transport position of the substrate measured by the position measurement portion.

17: The electrode forming system according to claim 8, further comprising a position measurement portion configured to measure a transport position of the substrate,
wherein the roller controls a rotational speed of the roller in accordance with the transport position of the substrate measured by the position measurement portion.

18: The electrode forming system according to claim 9, further comprising a position measurement portion configured to measure a transport position of the substrate,
wherein the roller controls a rotational speed of the roller in accordance with the transport position of the substrate measured by the position measurement portion.

19: The electrode forming system according to claim 10, further comprising a position measurement portion configured to measure a transport position of the substrate,
wherein the roller controls a rotational speed of the roller in accordance with the transport position of the substrate measured by the position measurement portion.

20: The electrode forming system according to claim 8, wherein the roller controls a rotational speed of the roller in accordance with a transport speed of the substrate in the transport device.

21: The electrode forming system according to claim 9, wherein the roller controls a rotational speed of the roller in accordance with a transport speed of the substrate in the transport device.

22: The electrode forming system according to claim 10, wherein the roller controls a rotational speed of the roller in accordance with a transport speed of the substrate in the transport device.
